(19) United States
(12) Patent Application Publication
(10) Pub. No.: US 2026/0158426 A1
(43) Pub. Date: Jun. 11, 2026

(54) VACUUM CLEANER FILTER BAG AND METHOD FOR PREPARING THE VACUUM CLEANER FILTER BAG

(71) Applicant: ESSILOR INTERNATIONAL, CHARENTON-LE-PONT (FR)

(72) Inventors: Zibin YAO, CHARENTON-LE-PONT (FR); Saitang WEI, CHARENTON-LE-PONT (FR); Bin OUYANG, CHARENTON-LE-PONT (FR)

(21) Appl. No.: 19/181,043

(22) Filed: Apr. 16, 2025

(30) Foreign Application Priority Data
Apr. 18, 2024 (EP) 24315191.7

(51) Int. Cl. B01D 39/16

(52) U.S. Cl. CPC B01D 39/1638; B01D 2101/00; B01D 2239/1241

(57) ABSTRACT

The invention relates to vacuum cleaner filter bag for ophthalmic lens engraving, comprising a filter bag body forming a volume and expandable polystyrene (EPS) particles disposed in the volume. The invention extends the life of the filter bag.

### FIELD OF INVENTION

The present invention relates to field of vacuum cleaner technology, more specifically to vacuum cleaner filter bags designed to enhance dust collection efficiency and extend the lifespan of the filter bags used in residential or commercial vacuum cleaning equipment, particularly those involved in environments producing sticky dust particles, like ophthalmic lens engraving.

### BACKGROUND

In the domain of ophthalmic lens manufacturing, engraving, especially laser engraving on the concave surfaces of lenses to embed a data matrix, is crucial for meticulously tracking each lens through its manufacturing stages. This method leverages laser technology to precisely etch information onto the lens without direct contact, eliminating the need for consumables such as inks or tool bits, thus offering unmatched efficiency and durability advantages. Notably, the process of laser engraving polycarbonate (PC) lenses is marked by the laser light's ability to burn the lens surface delicately. This action, essential for the permanence of the data matrix, enables the accurate tracking of production parameters like time, production line, and transfer trolley usage via the Manufacturing Execution System (MES), thereby significantly enhancing traceability and efficiency in the production of both finished and semi-finished lenses. However, it's important to acknowledge that the laser's interaction with the PC lens surface inevitably generates sticky dust, highlighting a consideration for environmental and workplace safety measures in the engraving process.

To solve issue, the existing technologies comprise using vacuum cleaner filter bags, particularly for industrial applications such as ophthalmic lens engraving, especially the polycarbonate (PC) lens engraving. However, the present vacuum cleaner filters face significant issues. These include rapid clogging due to sticky dust particles, necessitating frequent replacements that lead to operational inefficiencies and high cost.

Current solutions, like adding a back flushing function or increasing the filter bag's surface area, are insufficient. They either fail to effectively prevent rapid clogging or lead to workshop contamination during filter changes. The existing approaches, including the use of filter cylinders as alternatives to bags, have their own drawbacks, such as non-reusability, higher costs, and significant contamination issues during replacement due to dust accumulation on the outer surface of the filter cylinders. This situation underscores a pressing need for a more effective and cost-efficient solution to extend filter bag life while maintaining operational cleanliness and efficiency.

### SUMMARY

In this regard, according to one aspect of the invention, it is provided a vacuum cleaner filter bag for ophthalmic lens engraving, such as polycarbonate (PC) lens engraving, comprising a filter bag body forming a volume and expandable polystyrene (EPS) particles disposed in the volume so as to capture dust particles produced during the ophthalmic lens engraving.

With such an arrangement, the present invention increases the utility and effectiveness of the filter bag by maximizing dust capture and retention. The presence of EPS within the designated volume ensures an enhanced trapping mechanism for fine particles, especially during PC lens engraving.

Optionally, the EPS particles are evenly distributed within the volume of filter bag body. This ensures consistent dust capture throughout the filter bag, preventing areas of low efficiency and enhancing overall performance. Even distribution helps maintain optimal airflow and suction power.

Optionally, the EPS particles are spherical with a diameter of a range between 0.5 mm to 2 mm. Spherical particles promote better airflow and reduce the risk of clogging. The specified size range ensures that the particles can effectively trap dust while maintaining the flow of air.

Optionally, the total volume of the EPS particles is 680-1270 mL, which ensures sufficient coverage within the filter bag for effective dust capture without compromising airflow, offering an optimal balance between filtration efficiency and operational performance.

Optionally, the EPS particles are configured to utilize up to 10-20% of the volume of the filter bag body. This optimizes the available space within the filter bag for effective dust trapping while maintaining necessary air passage, thus extending the life of the filter bag without significant loss in suction power.

Optionally, the filter bag body can have any hollow shape. Such a versatility in shape accommodates various vacuum cleaner designs and user preferences, allowing for wide application and compatibility with different machines.

Optionally, the bag further comprises a tunnel connected to the filter bag body and with a diameter of, for example, more than 50 mm. This facilitates easy installation and removal while ensuring the EPS particles are not obstructed or compacted, maintaining effective dust capture and airflow.

According to a second aspect of the invention, it is provided a vacuum cleaner system for ophthalmic lens engraving, comprising the filter bag according to the present invention as discussed above and a vacuum source connected with the filter bag. With such an arrangement, it integrates the improved filter bag into a complete system, providing users with a ready-to-use solution that enhances the cleaning experience during the ophthalmic lens engraving.

Optionally, the vacuum source is configured to provide suction power of 16-30 mL/1 (m\hat{ }3/h). This tailors the vacuum's performance to work efficiently with the new filter design, ensuring that the enhanced dust capture capabilities of the EPS-enhanced filter bag are fully utilized.

According to a third aspect of the invention, it is provided a method for preparing a vacuum cleaner filter bag for ophthalmic lens engraving according to the present invention as discussed above, comprising adding EPS particles into the volume of the filter bag body for capturing dust particles produced during the ophthalmic lens engraving. It provides an innovative approach for incorporating EPS particles into filter bags, ensuring consistency and effectiveness in enhancing filter bag performance.

Optionally, it further comprises evenly distributing the EPS particles within the volume of the filter bag body. This ensures that the benefits of the EPS particles are realized throughout the entire filter bag, maintaining high dust capture efficiency and even airflow distribution during operation.

The present invention introduces several key advantages in the domain of vacuum cleaner filter technology, particularly for applications encountering sticky dust particles like those generated in ophthalmic lens engraving processes.

First, the invention significantly extends the lifespan of filter bags, which traditionally require frequent replacements due to rapid clogging. This extension not only reduces operational disruptions but also leads to substantial cost savings by lowering the frequency of filter replacements. Unlike prior solutions that focus solely on the surface area for dust collection, the introduction of expandable polystyrene (EPS) particles into the filter bag maximizes the use of the bag's volume, enhancing its dust holding capacity and ensuring more efficient particle capture.

Second, the invention ensures optimal airflow and improved filtration efficiency through the even distribution and specific sizing of EPS particles within the filter bag. This contributes to the vacuum cleaner maintaining peak performance over extended periods, thus improving the overall cleaning effectiveness.

Third, the invention accommodates filter bags of various shapes, increasing its applicability across different vacuum cleaner models and brands. One of the notable features of the invention is its capability to prevent significant workshop contamination during filter changes or cleaning of the EPS medium, addressing a common issue faced with existing filter systems.

Fourth, ease of cleaning and the potential for reuse of the EPS medium offer an environmentally friendly alternative to the traditional single-use filter bags, further contributing to operational cost savings and reducing waste. Specifically optimized for industrial applications that generate sticky dust particles, the invention provides a tailored solution to the unique challenges of such environments.

In summary, the present invention represents a comprehensive improvement over existing technologies in the field, addressing the need for a more efficient, cost-effective, and versatile solution to the challenges of maintaining optimal filter bag performance in environments with high particulate outputs.

### BRIEF DESCRIPTION OF THE DRAWINGS

Other features and advantages of the present invention will appear in the description hereinafter, in reference to the appended drawings, where:

FIG. 1 illustrates a folding vacuum cleaner dust bag according to the present invention distributed EPS particles.

### DESCRIPTION OF EMBODIMENTS

The present invention introduces an advanced solution to the persistent problem of filter bag clogging, specifically addressing the challenges faced in environments where sticky dust particles produced during the ophthalmic lens engraving, such as those from polycarbonate (PC) lens engraving processes, are prevalent.

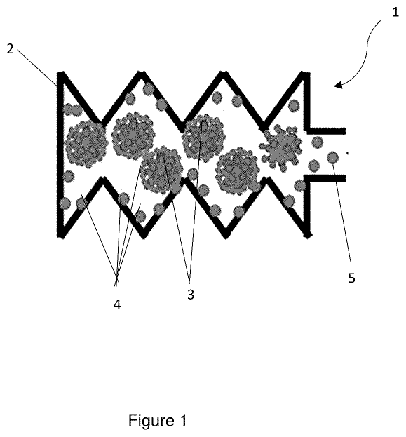

The vacuum cleaner filter bag, as exemplified in FIG. 1, is at the forefront of this innovation. FIG. 1 shows a vacuum cleaner filter bag 1 according to the present invention. It comprises a filter bag body 2 with a unique folding structure forming a volume which is for example an expansive internal volume. This volume is critical as it houses the innovative component of this invention: expandable polystyrene (EPS) particles 4.

These EPS particles 4 are not randomly dispersed within the filter bag 1 but are strategically and evenly distributed throughout the internal volume. This uniform distribution is advantageously for ensuring that all areas within the internal volume of the bag contribute effectively to dust capture, thereby maximizing the filter's overall efficiency.

The EPS particles 4 advantageously have spherical shape, with diameters meticulously chosen to range between 0.5 mm to 2 mm, ensures an optimal balance between surface area for dust capture and maintaining unimpeded airflow through the filter bag.

Moreover, the total volume of EPS particles introduced into the filter bag is specifically defined, with an ideal range set between 680-1270 mL. This volume is critical; it is calculated to ensure that the EPS particles occupy 10-20% of the filter bag body's volume. Such precise calibration ensures that the particles significantly enhance the bag's dust-holding capabilities without compromising airflow, which is crucial for the vacuum's operational efficiency.

The design flexibility extends to the shape of the filter bag body 2, which is adaptable to various vacuum cleaner designs by accommodating any hollow shape. This universal compatibility enhances the practical applicability of the filter bag across different vacuum cleaner models, thereby broadening the scope of the invention's utility.

An optional part of the design is the inclusion of a tunnel 5 connected to the filter bag body. This tunnel 5, designed with a diameter exceeding 50 mm, serves multiple functions. It facilitates the easy installation and removal of the filter bag, ensures that the EPS particles 4 do not face obstruction, and maintains efficient airflow and effective dust transport into the bag 1.

In an exemplary vacuum cleaner system, not shown, it comprises the filter bag of claim 1 and a vacuum source connected with the filter bag, such as via the tunnel 5.

In operation, as the vacuum cleaner is activated, air along with dust particles 3, such as smoke particles generated in the ophthalmic lens engraving processes, is drawn into the bag body 2 through the tunnel 5. The EPS particles 4 attract and trap the dust particles 3 produced during the ophthalmic lens engraving, aided by their static properties and strategic distribution within the bag 1. The air, now purified, passes through the bag and exits the vacuum cleaner, leaving the trapped dust particles behind.

The present invention also relates to a method for preparing a vacuum cleaner filter bag. As an example, initially, a vacuum cleaner filter bag 1 is prepared to accommodate the EPS particles 4. This involves ensuring the bag is empty and its internal volume is suitable for the addition of EPS particles. The particles, chosen for their light weight and electrostatic properties which aid in dust attraction, are spherical and sized between 0.5 mm and 2 mm in diameter to optimize filtration without hindering airflow.

The process then involves introducing a precise volume of EPS particles into the filter bag, typically ranging from 680 mL to 1270 mL, to occupy 10-20% of the bag's volume. This specific volume ensures effective dust capture while maintaining optimal airflow.

Following the addition, the EPS particles are evenly distributed within the filter bag. This step is intended to prevent any blockages and ensure that each part of the bag contributes equally to the filtration process. The even distribution can be achieved through manual shaking or mechanical dispersion, ensuring the EPS particles are spread throughout the bag's volume, maximizing the filtration surface area.

In view of the above detailed embodiment, the present invention addresses the significant challenges inherent in environments generating sticky dust particles. The innovative use of EPS particles within a specially designed filter bag body not only extends the life of the filter bag but also ensures consistent performance, reduces the need for frequent replacements, and offers a sustainable, cost-effective solution to the prevalent issues faced with traditional vacuum cleaner filter bags in specific industrial settings.

1. A vacuum cleaner filter bag for ophthalmic lens engraving, comprising a filter bag body forming a volume and expandable polystyrene (EPS) particles disposed in the volume so as to capture dust particles produced during the ophthalmic lens engraving, wherein the EPS particles are evenly distributed within the volume of filter bag body, wherein the total volume of the EPS particles is 680-1270 mL.

2. The filter bag of claim 1, wherein the EPS particles are spherical with a diameter of a range between 0.5 mm to 2 mm.

3. The filter bag of claim 1, wherein the EPS particles are configured to utilize up to 10-20% of the volume of the filter bag body.

4. The filter bag of claim 1, wherein the filter bag body can have any hollow shape.

5. The filter bag of claim 1, wherein it further comprises a tunnel connected to the filter bag body and with a diameter of more than 50 mm.

6. A vacuum cleaner system for ophthalmic lens engraving, comprising the filter bag of claim 1 and a vacuum source connected with the filter bag.

7. The system of claim 6, wherein the vacuum source is configured to provide suction power of 16-30 mL/1 (m\hat{ }3/h).

8. A method for preparing a vacuum cleaner filter bag for ophthalmic lens engraving of claim 1, comprising adding EPS particles into the volume of the filter bag body for capturing dust particles produced during the ophthalmic lens engraving.

9. The method of claim 8, wherein it further comprises evenly distributing the EPS particles within the volume of the filter bag body.
